(19) United States
(12) Patent Application Publication
(10) Pub. No.: US 2025/0073114 A1
(43) Pub. Date: Mar. 6, 2025

(54) MASSAGER WITH FISHTAIL SWINGING FUNCTION

(71) Applicant: Zengling Liufu, Huazhou (CN)

(72) Inventor: Zengling Liufu, Huazhou (CN)

(21) Appl. No.: 18/950,240

(22) Filed: Nov. 18, 2024

(51) Int. Cl. A61H 15/00

(52) U.S. Cl. CPC A61H 15/0078

(57) ABSTRACT

The present disclosure discloses a massager with a fishtail swinging function, and relates to the field of massage instruments. The massager includes a hard outer shell, a driving unit, a swinging element, a supporting base, and a massage part. The driving unit is fixedly mounted in the hard outer shell, and drives the swinging element to swing back and forth. The positioning shaft is mounted in the through hole in a rotating fit manner. The swinging element drives the supporting base to swing back and forth along the positioning shaft. Since the driving unit can drive the massage part to swing back and forth, the skin can be effectively pushed for massage. Meanwhile, the massager can be applied to performing a massage action on the skins of various parts of the body, and has a wide range of applications.

### TECHNICAL FIELD

The present disclosure relates to the field of massage instruments, and in particular, to a massager with a fishtail swinging function.

### BACKGROUND

A massager is a new generation of health care equipment developed based on the physics, the bionics, the bioelectricity, the traditional Chinese medicine, and years of clinical practice. The massager not only has eight simulation functions, allowing a user to really get relaxed by experiencing the eight functions: acupuncture, massotherapy, kneading, hammering, cupping, gua sha (a traditional Chinese massage technique), slimming, and immune adjustment, but also has a unique effect of treating hypertension. Several independent soft touch massage heads can be used to relax the muscles, soothe the nerves, promote the blood circulation, strengthen the cell metabolism, enhance the skin elasticity, alleviate the fatigue, significantly reduce various chronic pains, acute pains, and muscle soreness, relax the body, reduce stress, and reduce skin wrinkles.

In daily life, as people are busy with work and are under increasing pressure, people need to relieve the stress and get relaxed, but they have very short break time. Therefore, many health care products have appeared on the market, such as massagers. However, the traditional massagers usually only achieve a vibration effect through a motor that vibrates at a frequency. The single vibration effect cannot provide users with a better massage experience.

For this purpose, a pinching type massager has been disclosed in the prior art (No. CN221357637U, filed on Jul. 19, 2024). A massage head is driven by a driving member in the pinching type massager to drive a soft sleeve to deform, so that the pinching type massager achieves a pinching massage effect. The soft sleeve has elasticity, which better fits the human skin during massage and brings a user with a better massage experience.

However, in the above solution, a middle position of the soft sleeve only has a vibration massage function. When the soft sleeve abuts against the skin for use, the middle position of the soft sleeve will not swing back and forth, so that a user will not feel a massage effect of pushing back and forth in the skin of the massaged part. Therefore, this solution is generally only applicable to joint positions. The small scope of application seriously affects the massage experience of the massager.

### SUMMARY

To overcome the drawbacks described above, the present disclosure provides a technical solution capable of solving the above problems.

A massager with a fishtail swinging function is provided, including a hard outer shell, a driving unit, a swinging element, a supporting base, and a massage part. The driving unit is fixedly mounted in the hard outer shell, and drives the swinging element to swing back and forth. A positioning shaft is fixedly mounted in the hard outer shell. A through hole is provided in the supporting base. The positioning shaft is mounted in the through hole in a rotating fit manner. The swinging element drives the supporting base to swing back and forth along the positioning shaft. The massage part is fixedly mounted at an upper end of the support base. The massage part extends out of the hard outer shell.

Further, the driving unit uses a deceleration driving motor; an eccentric seat is fixedly mounted at a rotor of the driving unit; an oblique hole is provided in the eccentric seat; an insertion shaft is formed at a bottom of the swinging element; and the insertion shaft is inserted into the oblique hole in a clearance fit manner.

Further, a U-shaped groove is provided in a top end of the swinging clement; rotating shafts are formed on front and rear sides of a bottom end of the supporting base; rotating holes are provided in two sides in the U-shaped groove; the through hole and the rotating holes are arranged in a manner of being perpendicular to each other; and the rotating shafts are mounted in the rotating holes in a rotating fit manner based on one-to-one correspondence.

Further, a soft silica gel element is fixedly mounted on an outer side of the massage part.

Further, the hard outer shell includes a left shell and a right shell; the left shell and the right shell are spliced and assembled by a bolt; and a soft silica gel cover sleeves the hard outer shell.

Further, a vibration motor is fixedly mounted between the supporting base and the massage part.

Further, an external thread is formed on an outer side of an upper end of the supporting base; an internal thread is formed on an inner side of a lower end of the massage element; and the external thread is mounted in the internal thread in a spiral fit manner.

Further, a battery, a magnetic charging assembly, and a printed circuit board (PCB) are fixedly mounted in the hard outer shell; the battery controls the driving unit and the vibration motor to work through the PCB; and the magnetic charging assembly charges the battery through the PCB.

Further, an upper shell and a lower shell are fixedly mounted in the hard outer shell; and the driving unit is mounted between the upper shell and the lower shell in a clearance fit manner.

Compared with the prior art, the present disclosure has the beneficial effects: During use, the massage part abuts against the skin. Since the driving unit can drive the massage part to swing back and forth, the skin can be effectively pushed for massage. Meanwhile, the massager can be applied to performing a massage action on the skins of various parts of the body, and has a wide range of applications.

The additional aspects and advantages of the present disclosure will be partially provided in the following descriptions, some of which will become apparent from the following descriptions, or learned through the practice of the present disclosure.

### BRIEF DESCRIPTION OF THE DRAWINGS

To describe the technical solutions in the embodiments of the present disclosure or in the prior art more clearly, the following briefly introduces the accompanying drawings for describing the embodiments or the related art. Apparently, the accompanying drawings in the following description show merely some embodiments of the present disclosure, and a person of ordinary skill in the art may still derive other drawings from the accompanying drawings without creative efforts.

FIG. 1 is a schematic structural diagram of the present disclosure;

FIG. 2 is a schematic diagram of an exploded structure according to the present disclosure;

FIG. 3 is a schematic diagram of an exploded structure, after the outer shell is hidden;

FIG. 4 is a schematic diagram of a cross-sectional structure of the present disclosure;

FIG. 5 is a schematic structural diagram of a massage part when swinging to the left;

FIG. 6 is a schematic structural diagram of a massage part when swinging to a middle position; and

FIG. 7 is a schematic structural diagram of a massage part when swinging to the right.

In the drawings: 1: hard outer shell; 1.1: left shell; 1.2: right shell; 2: driving unit; 3: swinging element; 4: supporting base; 5: massage part; 6: positioning shaft; 7: through hole; 8: eccentric seat; 9: oblique hole; 10: insertion shaft; 11: U-shaped groove; 12: rotating shaft; 13: rotating hole; 14: soft silica gel element; 15: soft silica gel cover; 16: vibration motor; 17: external thread; 18: internal thread; 19: battery; 20: magnetic charging assembly; 21: PCB; 22: upper shell; 23: lower shell; and 24: top shell for positioning.

### DETAILED DESCRIPTION OF THE EMBODIMENTS

The technical solutions of the present disclosure are clearly and completely described below in conjunction with the accompanying drawings. Apparently, the described embodiments are some embodiments of the present disclosure, rather than all the embodiments.

Components of the embodiments of the present disclosure commonly described and shown in the accompanying drawings here may be arranged and designed in a variety of different configurations. Therefore, the following detailed descriptions of the embodiments of the present disclosure provided in the accompanying drawings are not intended to limit the scope of the claimed present disclosure, but merely represents selected embodiments of the present disclosure.

All other embodiments obtained by a person of ordinary skill in the art based on the embodiments of the present disclosure without making creative efforts shall fall within the protection scope of the present disclosure.

In the descriptions of the present disclosure, it should be noted that orientations or positional relationships indicated by the terms “center”, “upper”, “lower”, “left”, “right”, “vertical”, “horizontal”, “inner”, “outer”, and the like are orientations or positional relationships as shown in the drawings, and are only for the purpose of facilitating and simplifying the descriptions of the present disclosure instead of indicating or implying that devices or elements indicated must have particular orientations, and be constructed and operated in the particular orientations, so that these terms are not construed as limiting the present disclosure. In addition, the terms “first”, “second”, and “third” are only for the purpose of description, and may not be understood as indicating or implying the relative importance.

In the description of the present disclosure, it should be noted that unless otherwise specified and limited, the terms “mount”, “connect”, and “connection” should be broadly understood. For example, it can be a fixed connection, detachable connection, integrated connection, mechanical connection, electrical connection, direct connection, indirect connection via an intermediate element, or internal communication between two elements. For those of ordinary skill in the art, the specific meanings of the aforementioned terms in the present disclosure can be understood based on specific conditions.

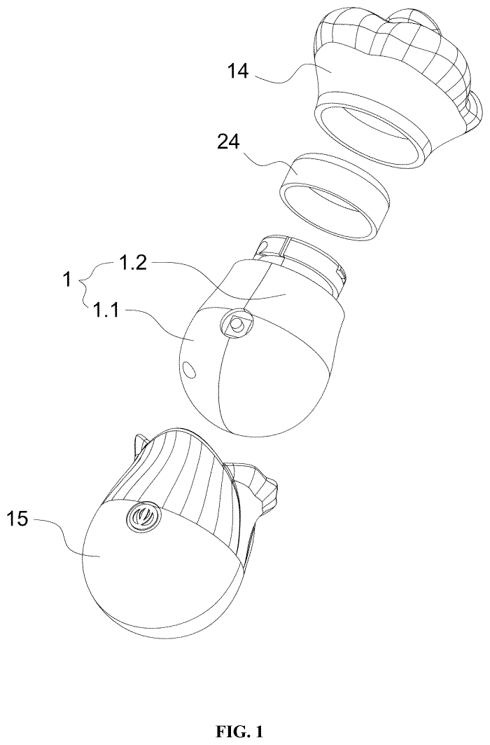

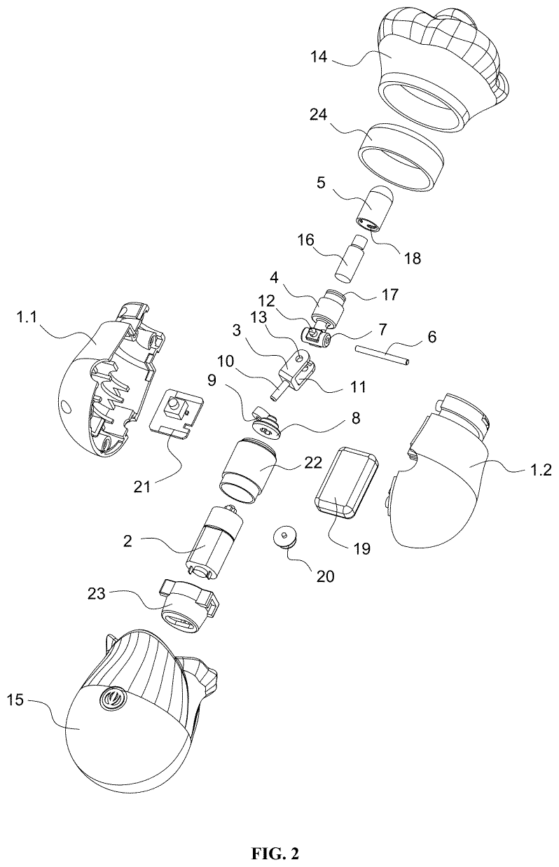

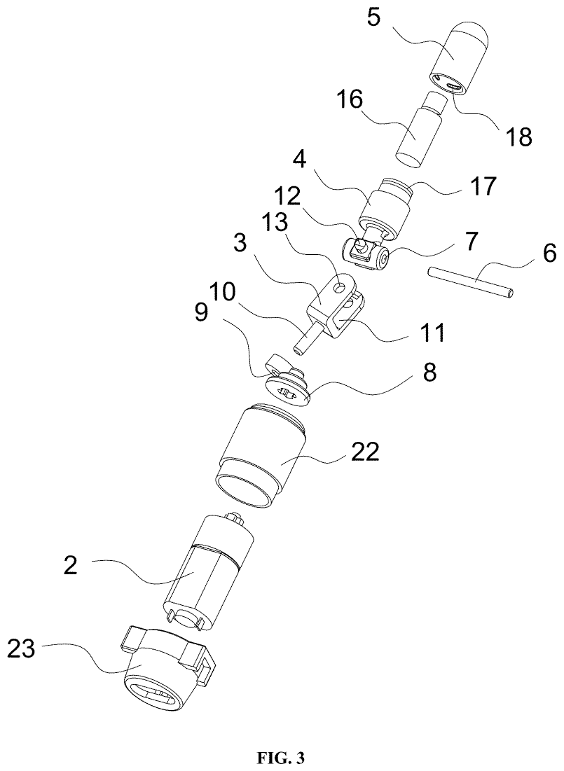

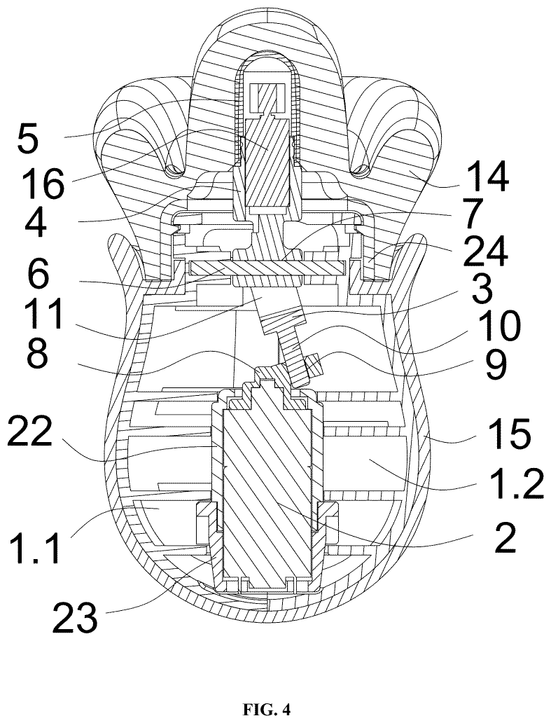

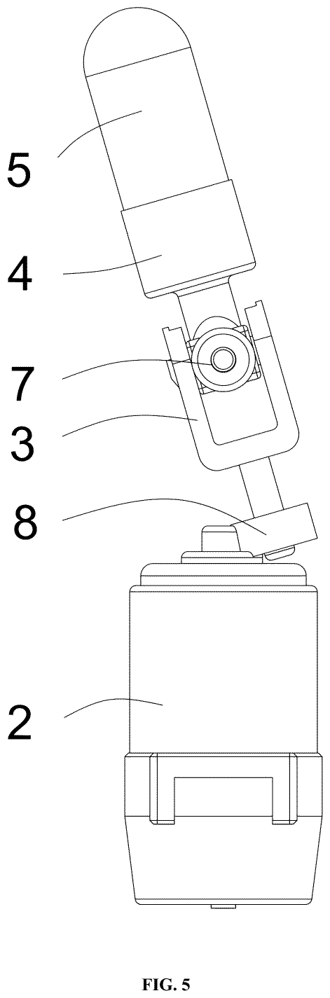

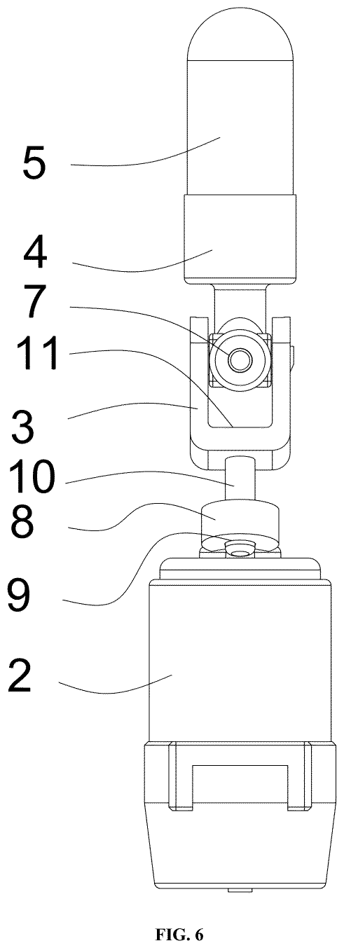

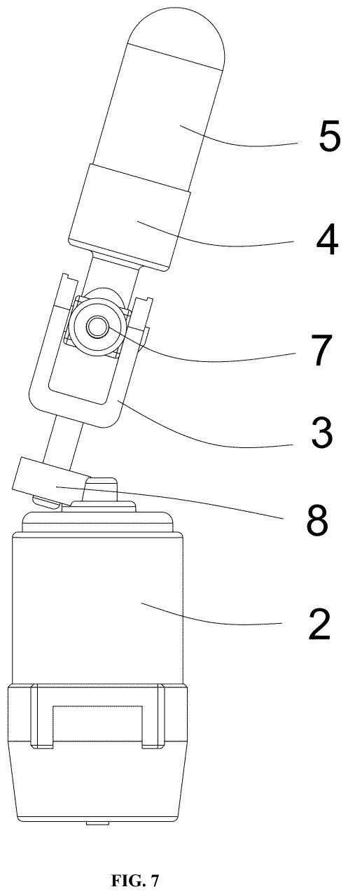

As shown in FIG. 1 to FIG. 7, the present disclosure provides a massager with a fishtail swinging function, including a hard outer shell 1, a driving unit 2, a swinging element 3, a supporting base 4, and a massage part 5. The driving unit 2 is fixedly mounted in the hard outer shell 1, and drives the swinging element 3 to swing back and forth. A positioning shaft 6 is fixedly mounted in the hard outer shell 1. A through hole 7 is provided in the supporting base 4. The positioning shaft 6 is mounted in the through hole 7 in a rotating fit manner. The swinging element 3 drives the supporting base 4 to swing back and forth along the positioning shaft 6. The massage part 5 is fixedly mounted at an upper end of the support base 4. The massage part 5 extends out of the hard outer shell 1.

The principle is as follows: During use, the driving unit 2 can drive the supporting base 4 to swing left and right through the swinging element 3. By the arrangement of the positioning shaft 6 and the through hole 7, it can ensure stable swinging of the supporting seat 4. In the swinging process, position offset will not occur. During use, the massage part 5 abuts against the skin. Since the driving unit 2 can drive the massage part 5 to swing back and forth, the skin can be effectively pushed for massage. The massager can be applied to performing a massage action on various parts of the body, and has a wide range of applications.

Further, the driving unit 2 uses a deceleration driving motor. An eccentric seat 8 is fixedly mounted at a rotor of the driving unit 2. An oblique hole 9 is provided in the eccentric seat 8. An insertion shaft 10 is formed at a bottom of the swinging element 3. The insertion shaft 10 is inserted into the oblique hole 9 in a clearance fit manner. The cooperation between the oblique hole 9 and the insertion shaft 10 can enable the deceleration driving motor to drive the swinging element 3 to swing back and force, thereby driving the supporting base 4 to swing back and forth along the positioning shaft 6. The massager has the characteristic of stable transmission, and the service life is prolonged.

Further, a U-shaped groove 10 is provided in a top end of the swinging element 3; rotating shafts 11 are formed on front and rear sides of a bottom end of the supporting base 4; rotating holes 12 are provided in two sides in the U-shaped groove 10; the through hole 7 and the rotating holes 12 are arranged in a manner of being perpendicular to each other; and the rotating shafts 11 are mounted in the rotating holes 12 in a rotating fit manner based on one-to-one correspondence. The supporting base 4 can be in rotating fit in the U-shaped groove 10 of the swinging element 3, so that the cooperation is more stable, and when swinging, the swinging element 3 can drive the supporting base 4 to synchronously swing.

Further, a soft silica gel element 13 is fixedly mounted on an outer side of the massage part 5, so that the massage part can better abut against the skin for use, and the massage effect is enhanced. The massager is applicable to the skin of the various parts of a human body, and the skin-friendly use experience is achieved.

Further, the hard outer shell 1 includes a left shell 1.1 and a right shell 1.2; the left shell 1.1 and the right shell 1.2 are spliced and assembled by a bolt; and a soft silica gel cover 14 sleeves the hard outer shell 1. By the arrangement of the left shell 1.1 and the right shell 1.2, it can be convenient to mount and remove the hard outer shell 1. After the mounting is completed, the soft silica gel cover 14 is used for wrapping to achieve sweatproof and oilproof effects. Meanwhile, the silica gel cover 14 further has a skin-friendly characteristic, so that the use experience is better.

Further, a vibration motor 15 is fixedly mounted between the supporting base 4 and the massage part 5, making the supporting base 4 further have a vibration effect when swinging back and forth for massage, thereby effectively enhancing the massage experience.

Further, an external thread 16 is formed on an outer side of an upper end of the supporting base 4; an internal thread 17 is formed on an inner side of a lower end of the massage element 5; and the external thread 16 is mounted in the internal thread 17 in a spiral fit manner. It can be convenient to mount and remove the vibration motor 15.

Further, a battery 18, a magnetic charging assembly 19, and a PCB 20 are fixedly mounted in the hard outer shell 1; the battery 18 controls the driving unit 2 and the vibration motor 15 to work through the PCB 20; and the magnetic charging assembly 19 charges the battery 18 through the PCB 20. The battery 18 is arranged in the hard outer shell 1. The massager does not need to be connected to an external power supply during use and is convenient to hold and use. The arrangement of the PCB 20 can control the driving unit 2 and the vibration motor 15 to be turned on and turned off, thereby facilitating actual control. When the battery 18 runs out, the magnetic charging assembly 19 can be used for magnetic charging, to facilitate actual use.

Further, an upper shell 21 and a lower shell 22 are fixedly mounted in the hard outer shell 1; and the driving unit 2 is mounted between the upper shell 21 and the lower shell 22 in a clearance fit manner. Therefore, the driving unit 2 is mounted in the hard outer shell 1 more stably and firmly.

This embodiment does not impose any formal limitations on the shape, material, structure, and the like of the present disclosure. Any simple modifications, equivalent changes, or embellishments made to the above embodiments according to the technical essence of the present disclosure shall all fall within the scope of protection of the technical solutions of the present disclosure.

What is claimed is:

1. A massager with a fishtail swinging function, comprising a hard outer shell, a driving unit, a swinging element, a supporting base, and a massage part, wherein the driving unit is fixedly mounted in the hard outer shell, and drives the swinging element to swing back and forth;
a positioning shaft is fixedly mounted in the hard outer shell; a through hole is provided in the supporting base; the positioning shaft is mounted in the through hole in a rotatable fit manner; the swinging element drives the supporting base to swing back and forth along the positioning shaft;
the massage part is fixedly mounted at an upper end of the support base; and the massage part extends out of the hard outer shell.

2. The massager with the fishtail swinging function according to claim 1, wherein the driving unit uses a deceleration driving motor; an eccentric seat is fixedly mounted at a rotor of the driving unit; an oblique hole is provided in the eccentric seat; an insertion shaft is formed at a bottom of the swinging element; and the insertion shaft is inserted into the oblique hole in a clearance fit manner.

3. The massager with the fishtail swinging function according to claim 1, wherein a U-shaped groove is provided in a top end of the swinging element; rotating shafts are formed on front and rear sides of a bottom end of the supporting base; rotating holes are provided in two sides in the U-shaped groove; the through hole and the rotating holes are arranged in a manner of being perpendicular to each other; and the rotating shafts are mounted in the rotating holes in a rotating fit manner based on one-to-one correspondence.

4. The massager with the fishtail swinging function according to claim 2, wherein a U-shaped groove is provided in a top end of the swinging element; rotating shafts are formed on front and rear sides of a bottom end of the supporting base; rotating holes are provided in two sides in the U-shaped groove; the through hole and the rotating holes are arranged in a manner of being perpendicular to each other; and the rotating shafts are mounted in the rotating holes in a rotating fit manner based on one-to-one correspondence.

5. The massager with the fishtail swinging function according to claim 1, wherein a soft silica gel element is fixedly mounted on an outer side of the massage part.

6. The massager with the fishtail swinging function according to claim 5, wherein a top shell for positioning is fixedly mounted between the hard outer shell and the soft silica gel element; and the soft silica gel element is fixedly mounted on at an upper end of the hard outer shell through the top shell for positioning.

7. The massager with the fishtail swinging function according to claim 1, wherein the hard outer shell comprises a left shell and a right shell; the left shell and the right shell are spliced and assembled by a bolt; and a soft silica gel cover sleeves the hard outer shell.

8. The massager with the fishtail swinging function according to claim 5, wherein the hard outer shell comprises a left shell and a right shell; the left shell and the right shell are spliced and assembled by a bolt; and a soft silica gel cover sleeves the hard outer shell.

9. The massager with the fishtail swinging function according to claim 1, wherein a vibration motor is fixedly mounted between the supporting base and the massage part.

10. The massager with the fishtail swinging function according to claim 9, wherein an external thread is formed on an outer side of an upper end of the supporting base; an internal thread is formed on an inner side of a lower end of the massage element; and the external thread is mounted in the internal thread in a spiral fit manner.

11. The massager with the fishtail swinging function according to claim 9, wherein a battery, a magnetic charging assembly, and a printed circuit board (PCB) are fixedly mounted in the hard outer shell; the battery controls the driving unit and the vibration motor to work through the PCB; and the magnetic charging assembly charges the battery through the PCB.

12. The massager with the fishtail swinging function according to claim 1, wherein an upper shell and a lower shell are fixedly mounted in the hard outer shell; and the driving unit is mounted between the upper shell and the lower shell in a clearance fit manner.
